(19) United States
(12) Patent Application Publication
(10) Pub. No.: US 2021/0334357 A1
(43) Pub. Date: Oct. 28, 2021

(54) METHOD OF MANAGING ACCOUNT LOGIN INFORMATION

(71) Applicant: eStorm Co., LTD., Seoul (KR)

(72) Inventor: Jong Hyun WOO, Seoul (KR)

(73) Assignee: eStorm Co., LTD., Seoul (KR)

(21) Appl. No.: 16/618,116

(22) PCT Filed: Nov. 27, 2019
(86) PCT No.: PCT/KR2019/016428

§ 371 Date: Nov. 28, 2019

(51) Int. Cl. G06F 21/46; G06F 21/31

(52) U.S. Cl. CPC G06F 21/46; G06F 21/31

(57) ABSTRACT

An account login information management method includes: performing, by a custom prudential provider installed in a computing device, operating system account authentication, supported by an operating system of the computing system, and alternative authentication; and changing, an account management client installed in the computing device, a password of an operating system account by updating an existing password used in the operating system account authentication with a new password.

### BACKGROUND

### Field

The present disclosure relates to a method of accessing an operating system (OS) account and, more particularly, to a method of managing account login information to access an OS account.

Description

According to the recent revision of the laws and regulations related to security, regulations requiring periodic changing of an OS account password used to log in to a Microsoft (MS) Windows-based system have been introduced. However, it may be inconvenient to periodically change the password of an OS account. If the password is changed (or updated) to be easy to remember to reduce user inconvenience, the security of the password may be lax, contrary to the intention of the regulations.

Accordingly, alternative authentication techniques enabling user authentication without the use of a user ID and a password have increasing been used. For example, Windows 10® may support a user login process of recognizing the face of a user using a camera mounted on a personal computer (PC) and, based on user face recognition, automatically performing a user login. In an OS in which the fast identity online (FIDO) Alliance authentication standard is used, the user login process is performed by fingerprint recognition, iris recognition, voice recognition, or the like. Although it is apparent that the alternative account authentication technique is convenient for users, it is the same as the past in terms of the system (i.e. regarding the internal operation of the OS) in which account access authentication should be performed using the password of the OS account of the user. That is, according to the alternative authentication technique, only a user authentication interface of the user is replaced with various means of authentication, but after authentication using an alternative means of authentication is completed, a process of authenticating a user using an OS account and a password of the user actually registered in the OS is still required to be performed. MS Windows supports an application programming interface (API), such that a third party may extend a credential provider so that a user can be authenticated using a variety of authentication methods. However, the process is performed using the OS account and the password of the user inside of the OS, and thus, a user session must be provided.

Consequently, even in the case in which the alternative authentication technique is performed, the password should be periodically updated in the same manner as in conventional cases, and thus, the inconvenience related to the update of the password is still present. Accordingly, even in the case in which the user authentication is performed by an alternative authentication technique, a solution able to automatically change the password of an OS account, managed inside the OS before the termination of a password change cycle, is required.

Solutions of changing the password of an OS account may include a method of forcibly initializing a corresponding password. For example, in a Windows system, functions used in relation to the initialization of the corresponding password may include a NetUserGetInfo function, a NetUserSetInfo function, or the like. However, when an existing password is forcibly initialized to be a new password, as described above, the existing credential (e.g. a service for providing a local computer with a safe storage space, in which a user name and a password used to log into websites, connected application programs, networks, and the like, are stored, and maintaining the safe storage space in the local computer) may be unavailable, which is problematic. Since the credential is to manage the password of a corresponding application by encoding the password of the corresponding application using the password of the existing OS account of the user, the existing credential cannot be used unless the user inputs a newly-generated OS account password while inputting the existing OS account password by reconstructing the existing OS account password.

Another method of changing the password of an OS account may include reconstructing (or restoring) the existing password and performing a password update (or reset) process using the reconstructed existing password and a newly-generated password. However, if the existing password has a value that can be simply reconstructed using information stored in a PC of the user, the OS account of the user may be cracked by a malicious party acquainted with password generating algorithms, such as a cracker, in the case that the malicious party has obtained values (or seed values) necessary for the reconstruction of the password. Thus, a security problem may also occur even with this method.

Accordingly, an alternative solution able to overcome all of the above-described problems is in demand.

### SUMMARY

Various aspects of the present disclosure provide a method able to not only automatically change a password of an operating system (OS) account of a user to comply with security regulations even in the case in which the user does not change the password of the OS account by him or herself, but also enhance the security of the automatically changed password of the OS account.

According to an aspect, an account login information management method may include:

performing, by a custom prudential provider installed in a computing device, operating system account authentication, supported by an operating system of the computing system, and alternative authentication; and

changing, an account management client installed in the computing device, a password of an operating system account by updating an existing password used in the operating system account authentication with a new password.

The password may be generated using a predetermined variable value in data, an access to which is not allowed without privilege of an operating system administrator, as one of seed values.

Here, the password may be a variable value in a log value, an access to which is not allowed without privilege of the operating system administrator, and be generated using an event time value of a password change event log as one of the seed values, the password change event log being accumulated whenever there is an attempt to change the password of the operating system account by the account management client.

Here, the changing of the password of the operating system account may include:

reconstructing the existing password used in the operating system account authentication;

generating the new password to be used in the operating system account authentication; and

updating the password of the operating system account using the reconstructed existing password and the generated new password.

The new password may be at least used and generated using an event time value of a most recently written event log of the password change event log cumulatively written whenever there is an attempt to change the password of the operating system account as one of the seed values.

The existing password may be reconstructed at least using an event time value of an event log, directly before the most recently written event log of the password change event log, as one of the seed values.

Here, the account login information management method may further include installing the account management client.

The installation of the account management client may be performed by the custom credential provider, and may include:

generating an account list according to operating system account information of the computing device when the installation of the account management client is requested;

newly generating operating system account passwords according to operating system accounts in the account list; and

changing the operating system account passwords according to the operating system accounts in the account list by updating the existing passwords with the newly-generated passwords according to the operating system accounts.

Each of the newly generated operating system account passwords may be generated at least using an event time value of a most recently written event log of the password change event log of a corresponding operating system account among the operating system accounts, at a corresponding point in time, as one of the seed values.

Here, the performing of the operating system account authentication may include:

performing the alternative authentication; and

after the alternative authentication is completed, reconstructing the existing password of the corresponding operating system account and performing the operating system account authentication using the reconstructed existing password.

The reconstruction of the existing password may be performed at least using an event time value of a most recently written event log of the password change event log of the corresponding operating system account, at a corresponding point in time, as one of the seed values.

As set forth above, the account login information according to embodiments of the present invention can not only automatically change a password of an OS account of a user to comply with security regulations even in the case in which the user does not change the password of the OS account by him or herself, but also can enhance the security of the automatically changed password of the OS account.

### BRIEF DESCRIPTION OF DRAWINGS

The above and other objects, features, and advantages of the present disclosure will be more clearly understood from the following detailed description, taken in conjunction with the accompanying drawings, in which:

FIG. 1 is a view illustrating a process of installing an account management client program for managing account login information according to an embodiment of the present invention;

FIG. 2 is a view illustrating an OS account authentication process by a custom credential provider according to the embodiment of the present invention;

FIG. 3 is a view illustrating an OS account password change process by an account management client according to the embodiment of the present invention;

### DETAILED DESCRIPTION

Since the present invention may have a variety of embodiments, which may be variously modified or altered, some embodiments of the present invention will be described hereinafter in detail with reference to the accompanying illustrative drawings. However, the present disclosure should not be construed as being limited to specific embodiments, but modifications, equivalents, and substitutions are possible without departing from the technical idea and scope of the present invention.

In the following description of the present invention, a detailed description of known functions and configurations incorporated herein will be omitted in the situation in which the subject matter of the present invention may be rendered rather unclear thereby. In addition, numerical values (e.g. first and second) used herein to describe the present invention are used merely as references to distinguish one component from other components.

In the case that it is described that a certain structural element “is connected to” or “is in contact with” another structural element, it should be interpreted that another structural element may “be connected to” or “be in contact with” the structural elements as well as that the certain structural element is directly connected to or is in direct contact with another structural element unless the context clearly indicates otherwise. It will be understood that the terms “comprise”, “include”, “have”, and any variations thereof used herein are intended to cover non-exclusive inclusions unless explicitly described to the contrary. In addition, the terms, such as “unit” or “module” used herein mean a unit or an entity for processing at least one function or operation, which may be implemented using hardware, software or a combination thereof.

In the present specification, a computing device using Microsoft Windows as an operating system (OS) will be described as an example for the sake of convenience and concentration of description, but it is apparent that the present invention is applicable to a user OS account authentication process in a variety of other operating systems, such as Linux.

In general, a credential provider means a user authentication management program or process that a corresponding OS provides by itself. For example, a credential provider provided by a Microsoft Windows OS displays an OS account authentication window (e.g. a login window into which a user name and a password are input) when a user computer is turned on. Thus, a user executes a user authentication process by inputting an ID and a password of his or her OS account in the login window. Here, in some cases, no separate user input may be required, since user account information regarding the ID and the password of the user is set to be default. Here, the password is required to be changed with the elapse of a predetermined period according to the security policy of the corresponding OS and according to password security regulations preset in the corresponding OS. For such reasons, a variety of problems related to the management of passwords may occur, as discussed above in the Background section.

In contrast, a custom credential provider means a program or processor supporting user authentication via a third alternative means of authentication, instead of being an authentication management module that that a corresponding OS provides by itself. Here, a third alternative authentication technique may use the fast identity online (FIDO) Alliance authentication standard, such as face recognition, fingerprint recognition, iris recognition, or voice recognition, a one-time password (OTP) input method, or a variety of other authentication solutions. In addition, the alternative authentication may be executed not only by a corresponding computing device (e.g. a personal computer (PC)) to which a user intends to log in, but also by a mobile device (or a user authentication application installed in the mobile device) of the user, able to work in concert with the corresponding computing device via Bluetooth or the like. The custom credential provider may be preinstalled in a user computer to support an alternative authentication solution. As described above, the present invention is discussed on the premise of performing a user authentication process about a corresponding OS (or a specific user account in the corresponding OS) using an alternative means of authentication.

However, according to an existing custom credential provider, only an OS authentication solution is replaced. That is, authentication performed by an OS itself is replaced with the alternative authentication solution, but the existing custom credential provider does not support periodic changing of an OS account password according to the security policy and password security regulations of the corresponding OS. Therefore, embodiments of the present invention will propose a novel method in which changing of an OS account password is periodically performed, or performed whenever OS account authentication is performed, by an account management client after alternative authentication and OS account authentication have been performed by the custom credential provider.

To solve the problems of the forced initialization of an OS account password as described above, the present invention basically employs a method of reconstructing an existing password of an OS account and performing a password update (or reset) process using the reconstructed existing password and a newly-generated password. In addition, a key technical feature of the present invention provides a solution to the problem of security vulnerability in that seed values necessary for the reconstruction of the existing password may be cracked by a malicious party, such as a cracker, since the seed values are stored in a PC. Specifically, the solution uses specific data values, which can only be accessed on the basis of administrator privilege, as one of the seed values for the generation of the OS account password. (According to embodiments of the present invention, the specific data values may be log values accumulating whenever there is an attempt to change the OS account password, or event time values of a password change event.)

Here, for the generation of the new OS account password, the event time value of the last accumulated password change event log (i.e. the most recently written password change event log) is used as one of the seed values. For the reconstruction of the existing OS account password, the event time value of the event log, before (or written directly before) the most recently written event log of the password change event log, is used as one of the seed values.

Accordingly, a specific value (or time) of information regarding the password change event, used as one of the seed values for the generation of the OS account password, can be prevented from being extracted (or cracked) by a third party (including a hacker) without administrator privilege, thereby enhancing security.

Although a case in which event time values of the password change event are used will be mainly described hereinafter, any predetermined variables within log values may also be used according to the technical concept of the present invention, as long as such variables cannot be accessed without the administrator privilege of the OS.

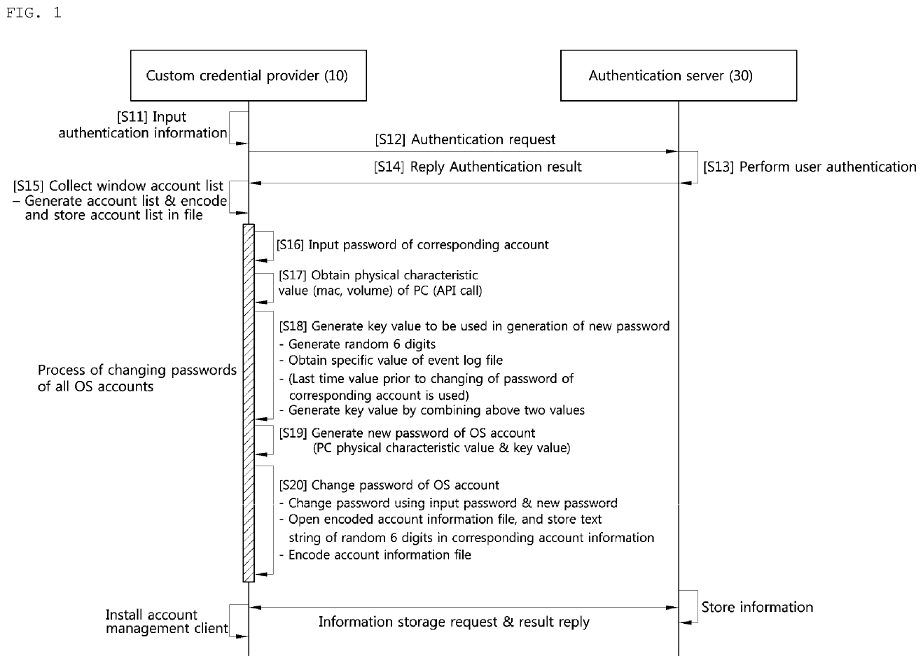

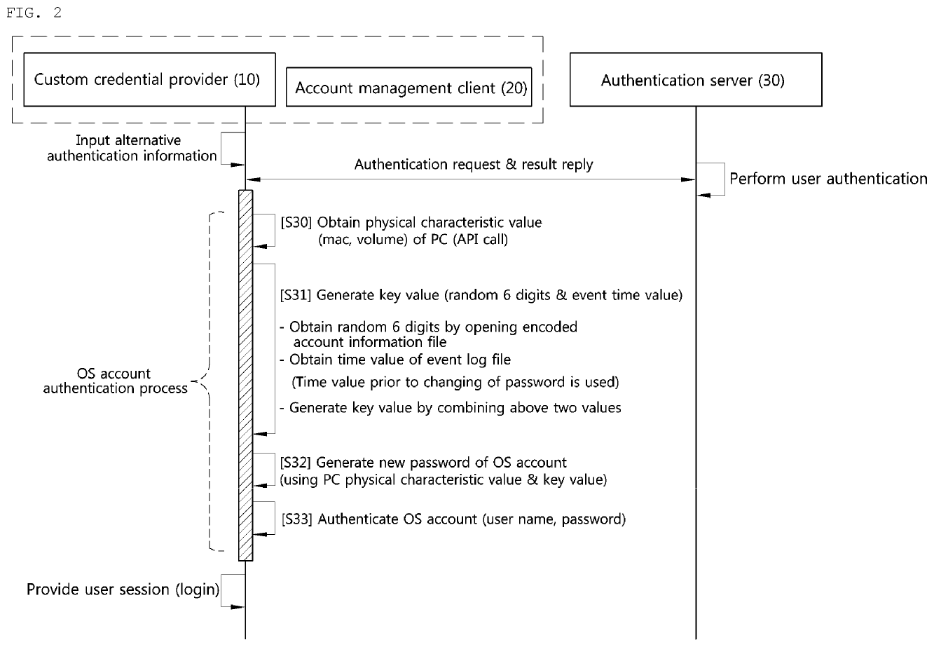

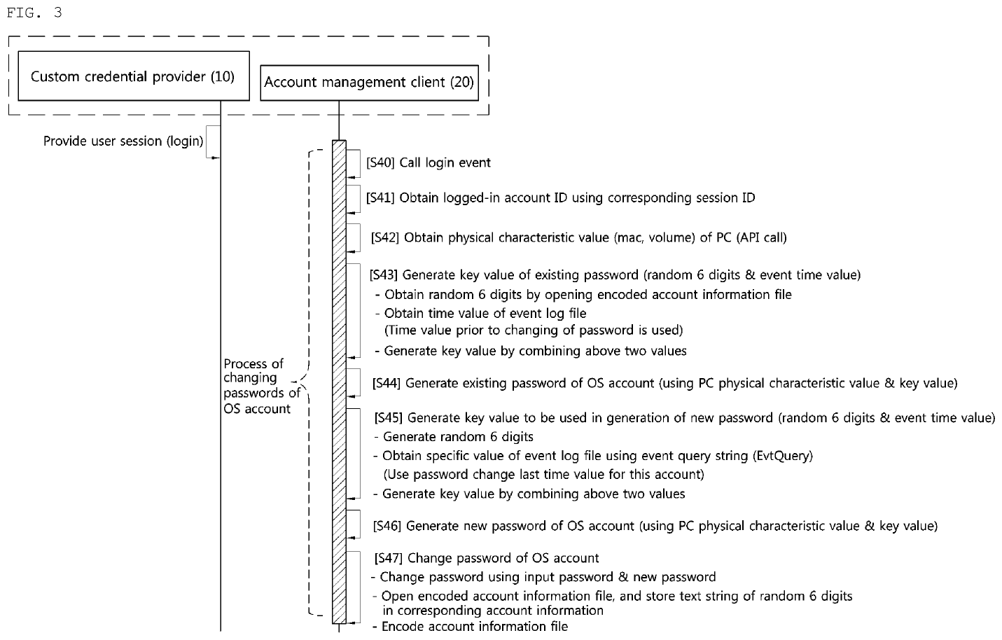

Hereinafter, the key technical features of the present invention as described above will be described in more detail with reference to the accompanying drawings, in which FIG. 1 is a view illustrating a process of installing an account management client program for managing account login information according to an embodiment of the present invention, FIG. 2 is a view illustrating an OS account authentication process by a custom credential provider according to the embodiment of the present invention, and FIG. 3 is a view illustrating an OS account password change process by an account management client according to the embodiment of the present invention.

It should be understood that reference numerals regarding individual steps (e.g. S11) illustrated in FIGS. 1 to 3, to be described hereinafter, are merely used to distinguish the individual steps from each other, but not to define the procedural sequence thereof. The respective steps may be performed in parallel or simultaneously, irrespective of the sequence of the reference numerals thereof, unless it is logically necessary that the steps are performed in the order of the reference numerals. In some cases, the steps may be performed in an order different from the order of the reference signs. The order of the steps may also be variously altered without departing from the key technical features of the present invention. Hereinafter, the steps will be described according to the order illustrated in the drawings, for the sake of convenience and concentration of description.

FIG. 1: Process of Installing Account Management Client

FIG. 1 is a view illustrating process steps of a process of installing an account management client program in a computing device, such as a PC in order to introduce a method of managing account login information according to the embodiment of the present invention.

Referring to FIG. 1, steps S11, S12, S13, and S14 illustrate a user authentication process performed by a specific user authentication solution, between the custom credential provider 10 installed in a corresponding computing device and an external authentication server 30, in an initial installation process of the account management client. A detailed description of the corresponding process will be omitted, since it is substantially the same as a typical program installation process.

When the user authentication for the program installation is completed, the custom credential provider 10 may collect information regarding all accounts of an OS installed in the corresponding computing device, generate an account list regarding the OS accounts, and encode and store the account list in a file. Afterwards, the custom credential provider 10 receives passwords of all accounts collected in the initial installation process of the account management client (see S16), and performs a process of changing the passwords of the all accounts into new passwords. In this case, some accounts, such as an account (e.g. an account used by the OS), the password of which cannot be changed by the user, an inactive account (i.e. a disabled account), and a guest account, may not be subjected to the above-described password change process.

According to the illustration of FIG. 1, the password change process and method may be as follows. Referring to FIG. 1, steps S17 to S20 illustrate a new password generating process. Specifically, a new password is generated by applying a password generating algorithm using a fixed key, such as a physical characteristic value (e.g. an MAC address or a hard disc volume ID) of the corresponding computing device, and a variable key, such as a random value (a random value of six (6) digits in the present embodiment) and an event time value, as a seed value for the password generation.

Here, a variety of other key values may be used in place of the fixed key, such as a physical characteristic value, and the variable key, such as a random value of six digits. Only the fixed key or the variable key may be used instead of using a combination of the fixed key and the variable key. A key technical feature of the present invention is to use the “event time value,” which is one of seed values used in the password generation (i.e. the reconstruction of an existing password and the generation of a new password), and which can only be accessed on the basis of administrator privilege to guarantee security. The event time value used herein means an event time value in password changing event information “most recently written” (i.e. related to a current password change attempt) from an accumulated event log updated whenever there is an attempt to change (or reset) an OS account password (i.e. NetUserChangePassword, an OS account password change function, is subjected to an API call in, for example, a Windows OS) as described above.

In addition, according to the illustration in FIG. 1, after a new password is generated using the above-mentioned event time value as one of the password generation seed values, the password changing is performed using the existing password, input in step S16, and the new password, generated in step S19. Afterwards, an account information file, generated and encoded in step S15, is decoded and opened. Information regarding the seed values used in the generation of the new password, except for the above-mentioned event time value (in the present embodiment, only the random value of 6 digits are stored, since only a PC physical characteristic value is extracted), and then, the account information file is encoded. Afterwards, the custom credential provider 10 stores information in relation to the authentication server 30, thereby completing the installation of the account management client.

As described above with reference to FIG. 1, when the account management client for executing the account login information management method according to the embodiment of the present invention is installed, a following OS account password change process is executed by processes illustrated in FIGS. 2 and 3. Although the illustrations in FIGS. 2 and 3 provide a case in which an OS account password is changed whenever user authentication is performed by a user on the basis of an alternative authentication solution, it is apparent that the changing of the OS account password may be performed in accordance with a password change cycle. Hereinafter, descriptions will be given with reference to FIGS. 2 and 3.

FIG. 2: OS Account Authentication Process

As described above, even in the case in which alternative authentication is performed via the custom credential provider and the authentication server 30, authentication of the corresponding OS account should be performed inside of the OS. Accordingly, the corresponding OS account authentication process is illustrated in FIG. 2 (steps S30 to S33).

When the alternative authentication is performed as illustrated in FIG. 2, the custom credential provider 10 reconstructs the password of the OS account using information necessary for OS account login, such as an OS account ID of the user of the alternative authentication. In this regard, the custom credential provider 10 may store a file of mapping information obtained by mapping an alternative authentication account of the user by third alternative authentication and the OS account of the user.

That is, after the alternative authentication is performed, the OS account authentication (i.e. the login) can be completed after the existing password, generated in the same manner as illustrated in FIG. 1, is actually input. Thus, the custom credential provider 10 reconstructs (or restores) the password, which was generated in advance, sequentially according to steps S30 to 32), and then performs the OS account authentication according to step S33. Here, detailed descriptions of steps S30 to S32 will be omitted, since they are substantially the same as steps S17 to S19 described above with reference to FIG. 1. When the OS account authentication using the existing password, reconstructed as above, is succeeded, a corresponding user session is provided (i.e. the login is completed).

FIG. 3: OS Account Password Change Process

After the user session is provided in response to the completion of the OS account authentication by the process described above with reference to FIG. 2, an OS account password change process according to the embodiment of the present invention is performed by the account management client 20, installed by the process in FIG. 1.

That is, the account management client 20 may detect a login event (SessionLogon in the Windows OS) on the basis of an event (e.g. OnSessionChange in the Windows OS) notifying changes in the OS session state when the user session is provided, obtain a logged-in session ID when the session event is detected, and obtain an ID of the corresponding account on the basis of the session ID (see steps S40 and S41). In addition, the account management client 20 may. Consequently, a process of changing the OS account password may be performed (see steps S42 to S47).

At this time, the password change is performed by the password update (or reset) process of reconstructing an existing password and generating a new password, instead of the above-described forced password initialization. In addition, the reconstruction of the existing password (steps S43 and S44) is substantially the same as steps S31 and S32 described above with reference to FIG. 2, the generation of the new password is substantially the same as steps S18 and S19 described above with reference to FIG. 1, and the password update (or reset) process (step S47) is substantially the same as step S20 described above with reference to FIG. 1, and thus, detailed descriptions thereof will be omitted.

As set forth above, the present invention can reconstruct (or restore) the existing OS account password. Accordingly, the same technical concept may be applied to an offline OS account authentication process in addition to the online OS account authentication process as described above with reference to FIGS. 1 to 3. In addition, although FIGS. 1 and 2 illustrate a case in which a remote authentication server connected to the corresponding computing device via a network participates in the alternative authentication process, a stand-alone system in which an agent program for processing the alternative authentication is installed, and operates, inside of the computing device may also be realized.

In the account login information management method according to embodiments of the present invention, the user is not required to remember his or her OS account, since only the user authentication is required to be performed by the alternative authentication solution. The OS account password can be automatically changed to comply with security regulations, instead of requiring the user to change the OS account password by him or herself. In addition, since the forced password initialization method is not used, existing credential data can still be used.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed is:

1. An account login information management method comprising:
performing, by a custom prudential provider installed in a computing device, operating system account authentication, supported by an operating system of the computing system, and alternative authentication; and
changing, an account management client installed in the computing device, a password of an operating system account by updating an existing password used in the operating system account authentication with a new password,
wherein the password is generated using a predetermined variable value in data, an access to which is not allowed without privilege of an operating system administrator, as one of seed values.

2. The account login information management method according to claim 1, wherein the password is a variable value in a log value, an access to which is not allowed without privilege of the operating system administrator, and is generated using an event time value of a password change event log as one of the seed values, the password change event log being accumulated whenever there is an attempt to change the password of the operating system account by the account management client.

3. The account login information management method according to claim 2, wherein the changing of the password of the operating system account comprises:
reconstructing the existing password used in the operating system account authentication;
generating the new password to be used in the operating system account authentication; and
updating the password of the operating system account using the reconstructed existing password and the generated new password,
the new password is at least used and generated using an event time value of a most recently written event log of the password change event log cumulatively written whenever there is an attempt to change the password of the operating system account as one of the seed values, and
the existing password is reconstructed at least using an event time value of an event log, directly before the most recently written event log of the password change event log, as one of the seed values.

4. The account login information management method according to claim 2, further comprising installing the account management client,
wherein the installation of the account management client is performed by the custom credential provider, and comprises:
generating an account list according to operating system account information of the computing device when the installation of the account management client is requested;
newly generating operating system account passwords according to operating system accounts in the account list; and
changing the operating system account passwords according to the operating system accounts in the account list by updating the existing passwords with the newly-generated passwords according to the operating system accounts,
wherein each of the newly generated operating system account passwords is generated at least using an event time value of a most recently written event log of the password change event log of a corresponding operating system account among the operating system accounts, at a corresponding point in time, as one of the seed values.

5. The account login information management method according to claim 2, wherein the performing of the operating system account authentication comprises:
performing the alternative authentication; and
after the alternative authentication is completed, reconstructing the existing password of the corresponding operating system account and performing the operating system account authentication using the reconstructed existing password,
wherein the reconstruction of the existing password is performed at least using an event time value of a most recently written event log of the password change event log of the corresponding operating system account, at a corresponding point in time, as one of the seed values.
